(19) United States
(12) Patent Application Publication
(10) Pub. No.: US 2021/0150949 A1
(43) Pub. Date: May 20, 2021

(54) FAN WITH NON-ROTATING BILLBOARD FUNCTION

(71) Applicant: CHAMP TECH OPTICAL (FOSHAN) CORPORATION, Foshan (CN)

(72) Inventors: YUNG-PING LIN, New Taipei (TW); YONG-KANG ZHANG, Foshan (CN); HUNG-SHIUO HAN, New Taipei (TW); DONG-MING PAN, Foshan (CN)

(21) Appl. No.: 16/725,735

(22) Filed: Dec. 23, 2019

(30) Foreign Application Priority Data
Nov. 15, 2019 (CN) 201911116809.X

(51) Int. Cl. G09F 23/00; H02K 7/08; H02K 7/14; H02K 11/33; H02K 21/22; F04D 29/043; F04D 19/00

(52) U.S. Cl. CPC G09F 23/00; H02K 7/088; H02K 7/14; H02K 2211/03; H02K 21/22; F04D 29/043; F04D 19/002; H02K 11/33

(57) ABSTRACT

A fan that is able to display an advertisement or other visible message includes a stator assembly, a rotating assembly, and a decoration member. The stator assembly includes a base, a fixing shaft, and a stator. The fixing shaft is positioned at the base. The stator is annular and positioned outside the fixing shaft. The rotating assembly is sleeved on the fixing shaft. The decoration member is fixedly connected to one end of the fixing shaft away from the base. The stator drives the rotating assembly to rotate around the fixing shaft while the stationary decoration member carries the display.

### FIELD

The subject matter herein generally relates to a fan and in particular to, a fan providing advertising.

### BACKGROUND

Generally, a fan cover is added to a rotor of a fan, and a specific pattern or an advertisement will be printed on the fan cover to realize publicity.

However, the fan cover usually rotates with the rotor. In this way, the rotating fan cover will cause the specific patterns or advertisement printed on it to be unreadable, and the publicity will be greatly reduced.

Therefore, there is room for improvement.

### BRIEF DESCRIPTION OF THE DRAWINGS

Many aspects of the disclosure can be better understood with reference to the figure. The components in the figures are not necessarily drawn to scale, the emphasis instead being placed upon clearly illustrating the principles of the disclosure.

FIG. 1 is an isometric view of an assembled fan according to an embodiment of the present disclosure.

FIG. 2 is a cross-sectional view taken along line II-II of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

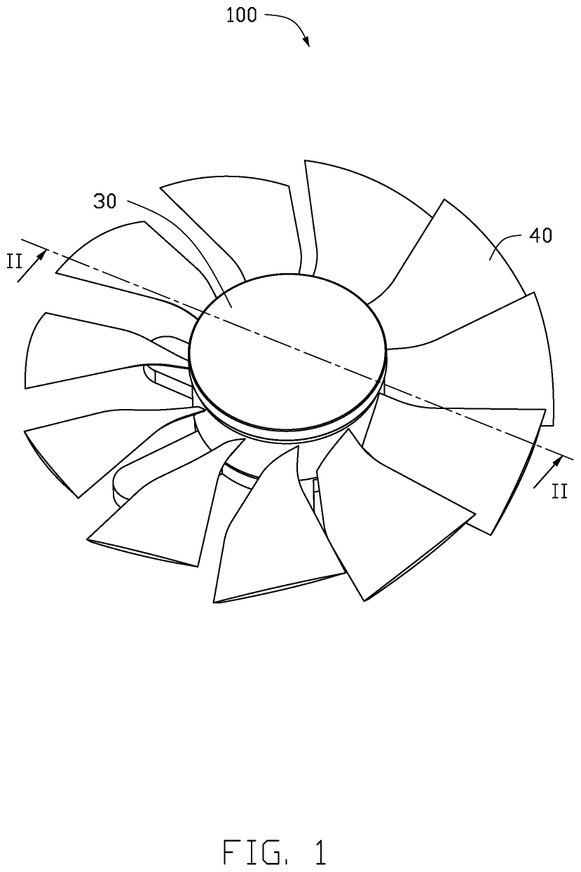

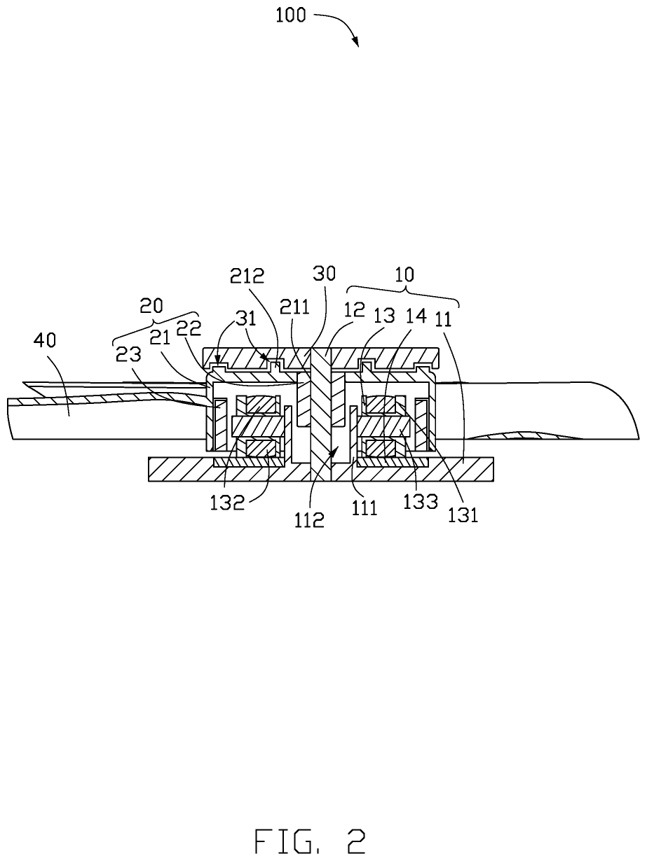

FIG. 1 and FIG. 2 illustrate a fan 100. The fan 100 includes a stator assembly 10, a rotating assembly 20, a decoration member 30, and at least one fan blade 40. The rotating assembly 20 is sleeved on the stator assembly 10 and is spaced apart from the stator assembly 10. The at least one fan blade 40 is positioned on the rotating assembly 20. When the fan 100 is running, the stator assembly 10 and the decoration member 30 remain stationary, and the rotating assembly 20 drives the at least one fan blade 40 to rotate around the stator assembly 10.

As illustrated in FIG. 2, in this embodiment, the stator assembly 10 includes a base 11, a fixing shaft 12, a stator 13, and a circuit board 14. The base 11 is configured to carry and support components of the fan 100. The base 11 can be made of plastic, metal, alloy, or other materials. The base 11 includes a shaft tube 111. The shaft tube 111 is substantially positioned at a central position of the base 11 and defines an opening 112. The shaft tube 111 may be integrally formed with the base 11 or may be separately provided. The shaft tube can be a steel pipe, a plastic pipe, or the like.

The fixing shaft 12 is received in the opening 112 and is spaced apart from an inner wall of the shaft tube 111.

The stator 13 is annular and positioned outside the shaft tube 111. The stator 13 is configured to drive the rotating assembly 20 to rotate. The stator 13 includes an insulation frame 131, a coil 132, and a magnetically conductive sheet 133. The insulation frame 131 is positioned outside the shaft tube 111. The coil 132 is positioned to surround the insulation frame 131. A material of the coil 132 may be metal, alloy, or other conductive materials.

The magnetically conductive sheet 133 is positioned outside the coil 132. The magnetically conductive sheet 133 is connected to the insulation frame 131. The magnetically conductive sheet 133 has magnetic permeability. The magnetically conductive sheet 133 is configured to assist in driving the rotating assembly 20 to operate. The magnetically conductive sheet 133 may be a silicon steel sheet or other magnetically conductive materials.

In this embodiment, the circuit board 14 is positioned between the base 11 and the stator 13. The circuit board 14 is electrically connected to the coil 132 to control the operation of the fan 100.

The rotating assembly 20 includes a rotor 21, a bearing 22, and a magnetic member 23. The bearing 22 is rotatably sleeved on the fixing shaft 12. The bearing 22 is partially located in the shaft tube 111 and is spaced apart from the base 11.

The rotor 21 is a casing with one end defining an opening. The rotor 21 is substantially cylindrical. A protrusion 212 extends from an upper surface of the rotor 21. The rotor 21 defines a through hole 211. The through hole 211 corresponds to the fixing shaft 12. By aligning the through hole 211 with the fixing shaft 12, the fixing shaft 12 can pass through the through hole 211. Then the rotor 21 is sleeved on the stator assembly 10 and covers the stator 13 and the circuit board 14. In one embodiment, an inner wall of the rotor 21 is spaced apart from the stator assembly 10.

The bearing 22 is movably sleeved on the fixing shaft 12 and is spaced apart from the shaft tube 111. The bearing 22 passes through the through hole 211, so that the rotor 21 is sleeved on the bearing 22. At this time, an outer wall of the bearing 22 is connected to an inside wall of the through hole 211, that is, the rotor 21 is fixedly connected to the bearing 22.

The magnetic member 23 is positioned on an inner wall of the rotor 21. The magnetic member 23 corresponds to the magnetically conductive sheet 133 and the coil 132. In this embodiment, the magnetic member 23 is a permanent magnet, or a magnet made of a synthetic rubber mixed with magnetic powder. The magnetic member 23 induces magnetism in the magnetically conductive sheet 133. The bearing 22 sleeved on the fixing shaft 12 does not contact with the base 11 during the rotation.

The decoration member 30 is fixedly connected to one end of the fixing shaft 12 away from the base 11. In this embodiment, the decoration member 30 is positioned above the rotating component 20. The decoration member 30 is positioned apart from the rotor 21 in the rotating assembly 20. A bottom of the decoration member 30 defines a groove 31. The groove 31 is substantially annular. The groove 31 corresponds to the protrusion 212 on the upper surface of the rotor 21. In this embodiment, the groove 31 cooperates with the protrusion 212 to seal/cover a gap between the rotor 21 and the decoration member 30, thereby preventing dust from entering the gap between the rotor 21 and the decoration member 30. Then, the bearing 22 rotates more smoothly. In this embodiment, a surface of the decoration member 30 away from the base 11 is printed with a pattern, for advertising or otherwise.

In this embodiment, the fan blades 40 are fixedly connected to the rotor 21 and are arranged radially outward.

In this embodiment, when the coil 132 is energized under a control of the circuit board 14, the current passes through the coil 132, electromagnetic induction occurs, and a magnetic field is induced. The induced magnetic field interacts with the magnetic member 23 and produces a repulsive effect, thereby driving the magnetic member 23 to operate. Since the magnetic member 23 is fixed to the inner wall of the rotor 21, the coil 132 will drive the rotor 21, the bearing 22, and the fan blade 40 to rotate around the fixing shaft 12. The decoration member 30 is fixedly connected to the fixing shaft center 12. Therefore, no matter how the rotor 21 rotates, the decoration member 30 and the fixing shaft 12 remain stationary.

In one embodiment, the bearing 22 may be an oil-containing bearing, a rotary bearing, a single ball bearing, a double ball bearing, or other type of bearings.

Since the fixing shaft 12 is fixed to the base 11, no matter how the rotation assembly 20 rotates, the decoration member 30 keeps stationary due to the fixed connection with the fixing shaft 12. Then, characters, patterns, and other displays printed on the decoration member 30 are always readable.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A fan comprising:
a stator assembly comprising a base, a fixing shaft, and a stator, wherein the fixing shaft is positioned at the base, wherein the stator is annularly shaped and is positioned outside the fixing shaft;
a rotating assembly sleeved on the fixing shaft; and
a decoration member fixedly connected to one end of the fixing shaft away from the base;
wherein the stator drives the rotating assembly to rotate around the fixing shaft while the decoration member remains stationary.

2. The fan of claim 1, further comprising a circuit board, wherein the circuit board is positioned between the base and the stator to power the stator.

3. The fan of claim 2, wherein the rotating assembly is spaced apart from the stator assembly, the rotating assembly comprises a rotor, a bearing, and a magnetic member; wherein the rotor is fixedly connected to the bearing, the bearing is movably sleeved on the fixing shaft, and the magnetic member is positioned on an inner wall of the rotor.

4. The fan of claim 3, wherein the stator comprises a coil and a magnetically conductive sheet, the coil is positioned to surround the magnetically conductive sheet and is electrically connected to the circuit board, and wherein when the coil is energized by the circuit board, the magnetic member becomes magnetically activated to drive the rotating assembly to rotate around the stator assembly.

5. The fan of claim 3, wherein the magnetic member is one of a permanent magnet and a magnet made of a synthetic rubber mixed with magnetic powder.

6. The fan of claim 4, wherein the magnetically conductive sheet is a silicon steel sheet.

7. The fan of claim 3, wherein the bearing is one of an oil-containing bearing, a rotary bearing, a single ball bearing, and a double ball bearing.

8. The fan of claim 3, wherein a protrusion extends from an upper surface of the rotor, a top surface of the decoration member comprises characters and patterns.

9. The fan of claim 8, wherein a bottom of the decoration member defines a groove, the groove corresponds to the protrusion, the groove cooperates with the protrusion to seal/cover a gap between the rotor and the decoration member.

10. The fan of claim 3, wherein the base comprises a shaft tube, the stator is sleeved on the shaft tube, and the bearing is spaced apart from the shaft tube.

11. A fan comprising:
a stator assembly, wherein the stator assembly comprises a base, a fixing shaft, and a stator, wherein the fixing shaft is positioned at the base, the stator is annularly shaped and is positioned outside the fixing shaft;
a rotating assembly sleeved on the fixing shaft;
at least one fan blade fixed on the rotating assembly, and
a decoration member fixedly connected to one end of the fixing shaft away from the base;
wherein the stator drives the rotating assembly to rotate around the fixing shaft, the at least one fan blade rotates along with the rotating assembly while the decoration member remains stationary and carries a display.

12. The fan of claim 11, further comprising a circuit board, wherein the circuit board is positioned between the base and the stator to power the stator.

13. The fan of claim 12, wherein the rotating assembly is spaced apart from the stator assembly, the rotating assembly comprises a rotor, a bearing, and a magnetic member; wherein the rotor is fixedly connected to the bearing, the bearing is movably sleeved on the fixing shaft, and the magnetic member is positioned on an inner wall of the rotor.

14. The fan of claim 13, wherein the stator comprises a coil and a magnetically conductive sheet, the coil is positioned to surround the magnetically conductive sheet and is electrically connected to the circuit board, and wherein when the coil is energized by the circuit board, the magnetic member becomes magnetically activated to drive the rotating assembly to rotate around the stator assembly.

15. The fan of claim 13, wherein the magnetic member is one of a permanent magnet and a magnet made of a synthetic rubber mixed with magnetic powder.

16. The fan of claim 14, wherein the magnetically conductive sheet is a silicon steel sheet.

17. The fan of claim 13, wherein the bearing is one of an oil-containing bearing, a rotary bearing, a single ball bearing, and a double ball bearing.

18. The fan of claim 13, wherein a protrusion extends from an upper surface of the rotor, a top surface of the decoration member forms characters and patterns for a publicity effect.

19. The fan of claim 18, wherein a bottom of the decoration member defines a groove, the groove corresponds to the protrusion, the groove cooperates with the protrusion to seal/cover a gap between the rotor and the decoration member.

20. The fan of claim 13, wherein the base comprises a shaft tube, the stator is sleeved on the shaft tube, and the bear is spaced apart from the shaft tube.
